(19) United States
(12) Patent Application Publication
(10) Pub. No.: US 2006/0039044 A1
(43) Pub. Date: Feb. 23, 2006

(54) Self-aligned image sensor and method for fabricating the same

(75) Inventor: Yeong Sil Kim, Suwong City (KR)

Correspondence Address: THE LAW OFFICES OF ANDREW D. FORTNEY, PH.D., P.C., 7257 N. MAPLE AVENUE, BLDG. D, SUITE 107, FRESNO, CA, 93720, US

(73) Assignee: DongbuAnam Semiconductor Inc.

(21) Appl. No.: 11/205,543

(22) Filed: Aug. 16, 2005

(30) Foreign Application Priority Data
Aug. 20, 2004 (KR) 10-2004-0065742

(51) Int. Cl. H04N 1/04

(52) U.S. Cl. 358/512; 358/483

(57) ABSTRACT

A self-aligned image sensor and a method for fabricating the same is disclosed, that decrease production cost and reduce or prevent misalignment between a micro-lens and a color filter. A protection layer having a flat upper surface is formed on a semiconductor substrate that includes image sensor elements, such as photodiodes, therein. A color filter is then formed on the protection layer, and then a micro-lens is formed in, on or from the color filter by reflowing the color filter material, so that the color filter and the micro-lens are self-aligned.

### CROSS-REFERENCE TO RELATED APPLICATIONS

This application claims the benefit of Korean Application No. P2004-65742 filed on Aug. 20, 2004, which is hereby incorporated by reference as if fully set forth herein.

### BACKGROUND OF THE INVENTION

1. Field of the Invention

The present invention relates to a self-aligned image sensor and a method for fabricating the same, and more particularly, to a self-aligned image sensor and a method for fabricating the same in which a protection layer having a flat upper surface is on a semiconductor substrate including image sensor elements (such as photodiodes), a color filter is on the protection layer, and a micro-lens is formed by reflowing the color filter, so that the color filter and the micro-lens are self-aligned.

2. Discussion of the Related Art

Generally, an image sensor is a semiconductor module for converting an optical image to an electric signal. The image sensor is used for storing, transferring and displaying image signals.

The image sensor can be broadly categorized into a charge-coupled device (hereinafter, referred to as CCD) and a complementary metal oxide semiconductor image sensor (hereinafter, referred to as CMOS image sensor, or CIS). The CCD transfers electric charges to a desired direction by sequentially controlling a depth of a potential well. In case of the CIS, at least one transistor and at least one photodiode are provided in one unit cell.

In comparison to the CMOS image sensor, the CCD has less noise and greater image quality, whereby the CCD is suitable for a digital camera. Meanwhile, the CMOS image sensor is advantageous in that it has a low production cost. In addition, in case of the CMOS image sensor, it can be easily integrated into a peripheral circuit chip. Especially, the CMOS image sensor can be fabricated with a general semiconductor fabrication technology, and the CMOS image sensor can be integrated into a peripheral system that performs amplification and signal processing, so it is possible to decrease the production cost. Also, the CMOS image sensor has a rapid processing speed and low power consumption. For example, the power consumption of the CMOS image sensor corresponds to about 1% of the power consumption of the CCD. Furthermore, the CMOS image sensor is very suitable for a small-sized mobile terminal such as cameras of a mobile phone and/or a PDA. Recently, the CMOS image sensor may be used in various fields with the development of the CMOS technology.

The image sensor is provided with a photo-sensing portion and a logic circuit portion, wherein the photo-sensing portion senses the light, and the logic circuit portion converts the sensed light to an electric signal (e.g., data). In order to improve the photosensitivity, one should enhance a fill factor (i.e., proportion or percentage of the photo-sensing portion in the entire area of the image sensor). However, there is limit to the fill factor of the photo-sensing portion since it is impossible to completely remove the logic circuit portion. In another method, it has been proposed to apply a light-condensing technology to the image sensor. For example, a micro-lens is provided for condensing the light incident on the remaining portion to the photo-sensing portion by changing the light-path.

To realize color images, the image sensor includes a color filter array provided on the photo-sensing portion, wherein the color filter array is generally provided with red, green and blue color filter patterns (or, alternatively, yellow, magenta and cyan color filter patterns).

FIG. 1 is a cross sectional view of an image sensor according to the related art.

First, a protection layer 102 is formed on a semiconductor substrate 100 including a light-receiving area (not shown) such as a photodiode. Then, a color filter layer 104 is formed on the protection layer 102. In this case, the color filter layer 104 is formed by performing a photolithography process on each of red, green and blue patterns. Next, a planarization layer 106 is formed to cover the color filter layer 104, and micro-lenses 108 are formed on the planarization layer 106.

In a method for fabricating the image sensor according to the related art, misalignment may occur between the color filters and the micro-lenses, thereby causing problem in realizing color images. The micro-lens is generally formed by reflowing a resist at a relatively high temperature. In this case, the micro-lens is generally sensitive to the temperature and the thickness of resist. Thus, small changes or variations in temperature and/or resist thickness may cause the micro-lens to be misaligned with the color filter. Also, the planarization layer is generally formed to make forming the micro-lens easier. In addition, the micro-lens is formed separately from the color filter, whereby the production cost increases due to additional steps in the fabrication process.

To overcome these problems, Korean Application No. P2003-37292 discloses a method for fabricating an image sensor wherein a color filter and a micro-lens are formed of the same material at the same time. However, since a lower surface of the pattern for the color filter and the micro-lens is concave, an extra etching process may be necessary, thereby causing one or more additional steps in fabricating the image sensor, and increasing the production cost.

Also, Korean Application No. P2003-14243 discloses a method for fabricating an image sensor which can remove the process of forming a planarization layer. In the method for fabricating the image sensor in Korean Application No. P2003-14243, a color filter pattern is formed on a protection layer, and a micro-lens is formed in correspondence with the color filter pattern. That is, the micro-lens is directly formed on the color filter pattern. However, misalignment may occur between the color filter pattern and the micro-lens.

### SUMMARY OF THE INVENTION

Accordingly, the present invention is directed to a self-aligned image sensor and a method for fabricating the same that substantially obviates one or more problems due to limitations and disadvantages of the related art.

An object of the present invention is to provide a self-aligned image sensor and a method for fabricating the same that decrease production cost and reduce or prevent misalignment between a micro-lens and a color filter, in which a protection layer having a flat upper surface is formed on a semiconductor substrate that includes image sensor elements (such as photodiodes), a color filter is formed on the protection layer, and then the micro-lens is formed by reflowing the color filter material, so that the color filter and the micro-lens are self-aligned.

Additional advantages, objects, and features of the invention will be set forth in part in the description which follows and in part will become apparent to those skilled in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for fabricating a self-aligned image sensor includes forming a protection layer on a semiconductor substrate having image sensor elements; exposing predetermined portions of the protection layer for (subsequent) formation of color filters by depositing and patterning an oxide layer on the protection layer; coating resists for respective color filters in the predetermined portions of the patterned oxide layer; removing the oxide layer; and forming a micro-lens by reflowing the resists.

In another aspect, a self-aligned image sensor includes a protection layer on a semiconductor substrate having image sensor elements therein, wherein the protection layer has a flat upper surface; and a resist pattern on the protection layer, wherein the resist pattern functions as a color filter and a micro-lens.

At this time, the protection layer having the flat upper surface may be formed on the semiconductor substrate, and a convex-type resist pattern may be formed on the protection layer, wherein the convex-type resist pattern functions as the color filter and the micro-lens. Preferably, the protection layer comprises silicon nitride (Si₃N₄).

In the image sensor according to the present invention, it is possible to remove the planarization layer. Also, the color filter and the micro-lens are generally formed from the same material (e.g., a single resist layer), so that the color filter and the micro-lens may become self-aligned.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a cross sectional view of an image sensor according to the related art; and

FIG. 2A to FIG. 2E are cross sectional views of an exemplary process for fabricating an image sensor according to the present invention.

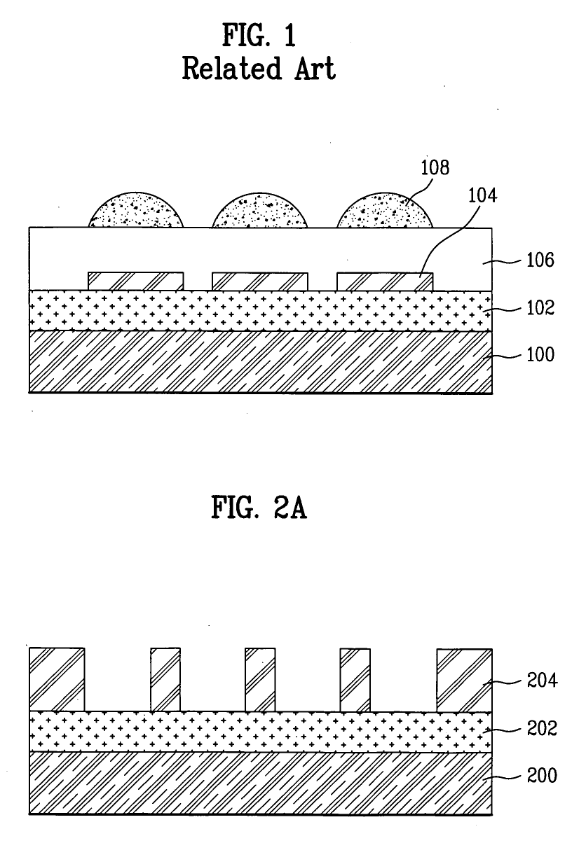

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a self-aligned image sensor and a method for fabricating the same according to the present invention will be described with reference to the accompanying drawings.

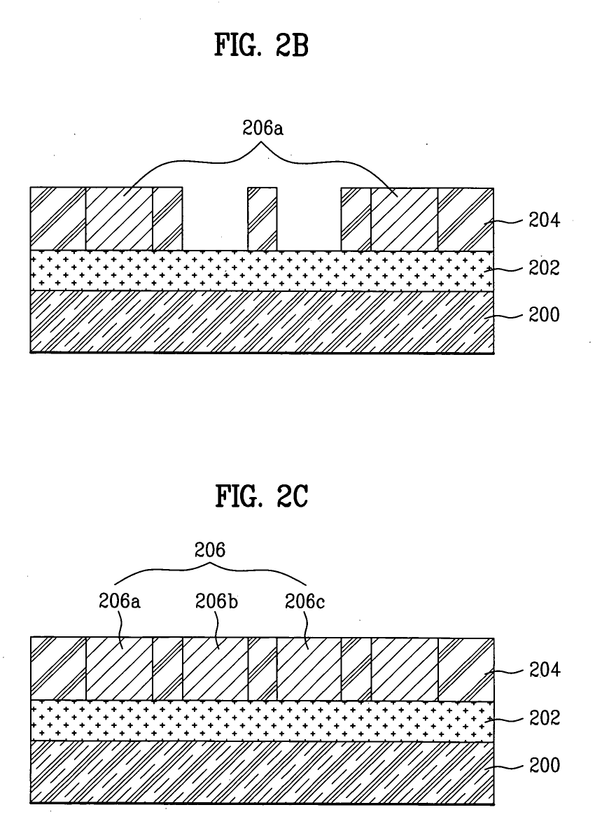

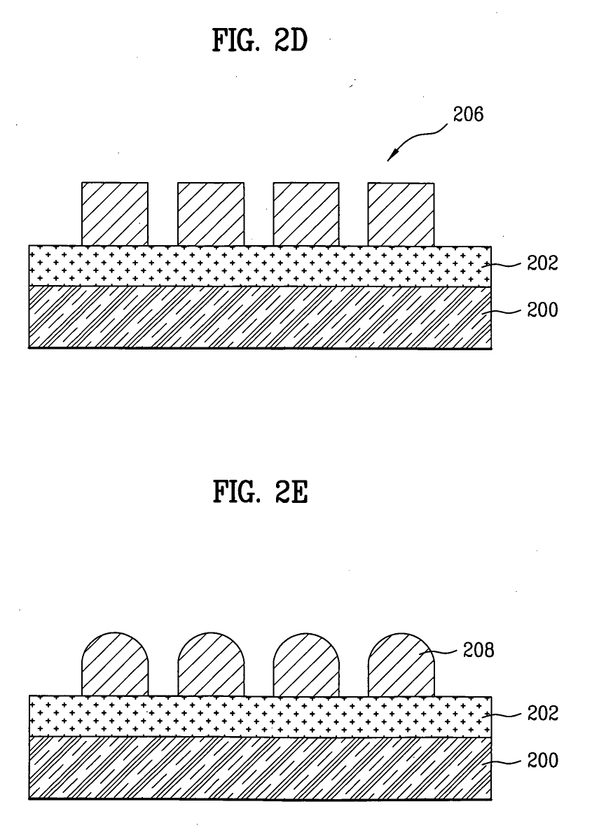

FIG. 2A to FIG. 2E are cross sectional views of the process for fabricating an image sensor according to the present invention.

First, image sensor elements (not shown) including a pixel having a light-receiving area such as a photodiode, an insulating interlayer and a metal line are formed in a semiconductor substrate 200 by an image sensor fabrication technology.

Next, as shown in FIG. 2A, a protection layer 202 is formed on the semiconductor substrate 200 (generally by chemical vapor deposition, or CVD), and an oxide layer 204 is patterned on the protection layer 202. Preferably, the protection layer 202 comprises a silicon nitride material (for example, Si₃N₄). Also, when forming the protection layer 202, a CMP (Chemical Mechanical Polishing) process may be performed to planarize, or obtain the flatness in, the upper surface of the protection layer 202.

Thereafter, an oxide layer 204 is formed on the protection layer 202, generally by blanket deposition (e.g., CVD, such as PE-CVD or HDP-CVD, from silicon sources such as TEOS or silane (SiH₄), and oxygen sources such as ozone (O₃) or oxygen (O₂), as is known in the art.

After the oxide layer 204 is formed on the protection layer 202, a photoresist (not shown) is coated thereon. Then, an exposure and development process is performed on the coated photoresist, whereby the photoresist comprises or is formed in a predetermined pattern. Using the photoresist pattern as an etching mask, the oxide layer 204 is etched, whereby the oxide layer 204 has or is formed in the predetermined pattern. In this case, the oxide layer 204 is (slightly) overetched), using the protection layer 202 (generally comprising a nitride material) as an end point. Also, the oxide layer 204 may be easily removed by a selective etching process after completing the formation of a self-aligned color filter. In an alternative embodiment, protection layer 202 may comprise an oxide (e.g., USG or FSG) and oxide layer 204 may be replaced with a nitride layer (effectively making layer 204 a “filter patterning layer”), as long as layers 202 and 204 have etch selectivity relative to each other.

As shown in FIG. 2B, a resist for a blue color filter is coated or deposited in one or more predetermined portions of the patterned oxide layer 204, and an exposure and development process (and optionally, a planarization process) is performed on the blue color filter resist, thereby forming a blue resist pattern 206a.

Then, as shown in FIG. 2C, a resist for a red color filter is coated in one or more second predetermined portions of the patterned oxide layer 204, and an exposure and development process (and optionally, a planarization process) is performed on the red color filter resist, thereby forming a red resist pattern 206b. Also, a resist for a green color filter is coated in the (remaining) predetermined portion(s) of the patterned oxide layer 204, and an exposure and development process (and optionally, a planarization process) is performed on the green color filter resist, thereby forming a green resist pattern 206c. Thus, the resists for blue, red and green color filters are formed on the exposed portions of the protection layer 202 and in the openings in patterned oxide layer 204.

Next, the color filter layer 206 is completed by removing the oxide layer 204. The color filter 206 is formed in correspondence or alignment with a photodiode (not shown, but generally located in an underlying portion of substrate 200) configured to receive the light from outside the CMOS image sensor, focused on the semiconductor substrate 200.

As shown in FIG. 2D, the upper surface of the color filter 206 may be formed into a micro-lens 208 by reflowing the color filter 206 at a temperature between 100° C. and 250° C., preferably from 150° C. to 200° C. Also, the micro-lens 208 generally comprises a resist material (e.g., the same resist material as color filter 206a, 206b or 206c) since the resist material forming micro-lens 208 also functions as the color filter. Thus, it is possible to prevent misalignment between the color filter and the micro-lens. In addition, the fabrication steps are simplified because it is possible to omit patterning and planarizing process steps for forming the micro-lens. Furthermore, the self-aligned image sensor according to the present invention may have improved light-transmitting efficiency since there is no planarization layer (which, under typical conditions, reflects some light back towards the micro-lens in a conventional CMOS image sensor).

In the self-aligned image sensor according to the preferred embodiment of the present invention, a first resist pattern (e.g., the blue resist pattern), a second resist pattern (e.g., the red resist pattern), and a third resist pattern (e.g., the green resist pattern) are formed in sequence. However, the order of forming a three-color resist pattern is not limited to this embodiment. For example, the blue, red and green resist patterns may be substituted with yellow, magenta and cyan resist patterns.

As mentioned above, the self-aligned image sensor and method for fabricating the same according to the present invention has the following advantages.

In the self-aligned image sensor and method according to the present invention, it is possible to omit a planarization layer. That is, the color filter and the micro-lens may comprise the same material, so that production costs may be reduced and fabrication steps may be simplified. In addition, it is possible to prevent misalignment between the color filter and the micro-lens, thereby preventing any significant decrease in yield.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for fabricating an image sensor comprising:
forming a protection layer on a semiconductor substrate having image sensor elements;
exposing predetermined portions of the protection layer for formation of color filters by depositing and patterning an oxide layer on the protection layer;
coating resists for respective color filters in predetermined portions of the patterned oxide layer;
removing the oxide layer; and
reflowing the resists to form micro-lenses therein, thereon or therefrom.

2. The method of claim 1, further comprising:
planarizing the protection layer by CMP after forming the protection layer.

3. The method of claim 1, wherein the step of coating the resists for respective color filters includes:
forming a blue color filter pattern by coating, exposing and developing a blue color filter resist;
forming a red color filter pattern by coating, exposing and developing a red color filter resist; and
forming a green color filter pattern by coating, exposing and developing a green color filter resist.

4. The method of claim 1, wherein reflowing comprises heating at a temperature of from 150° C. to 200° C.

5. A method for fabricating an image sensor comprising:
depositing and patterning a filter patterning layer on a protection layer on a semiconductor substrate having image sensor elements therein;
forming color filters in predetermined portions of the patterned filter patterning layer; and
forming a micro-lens in, on or from the color filters by reflowing the color filters.

6. The method of claim 5, further comprising forming the protection layer on the semiconductor substrate having image sensor elements therein.

7. The method of claim 6, further comprising planarizing the protection layer.

8. The method of claim 7, wherein planarizing the protection layer comprises polishing the protection layer.

9. The method of claim 5, wherein the step of forming color filters comprises:
forming a first color filter pattern by coating, exposing and developing a first color filter resist;
forming a second color filter pattern by coating, exposing and developing a second color filter resist different from the first color filter resist; and
forming a third color filter pattern by coating, exposing and developing a third color filter resist different from the first and second color filter resists.

10. The method of claim 5, wherein reflowing comprises heating at a temperature between 100° C. to 250° C.

11. The method of claim 10, wherein reflowing comprises heating at a temperature of from 150° C. to 200° C.

12. The method of claim 5, wherein the protection layer comprises a nitride layer.

13. The method of claim 5, wherein the filter patterning layer comprises an oxide layer.

14. An image sensor comprising:
a protection layer on a semiconductor substrate having image sensor elements, wherein the protection layer has a flat upper surface; and
a resist pattern on the protection layer, wherein the resist pattern functions as a color filter and a micro-lens.

15. The image sensor of claim 12, wherein the resist pattern comprises:
a first color filter pattern;
a second color filter pattern different from the first color filter pattern; and
a third color filter pattern different from the first and second color filter patterns.

16. The image sensor of claim 13, wherein the first, second and third color filter patterns comprise blue, red and green color filter patterns.

17. The image sensor of claim 13, wherein the first, second and third color filter patterns comprise yellow, magenta and cyan color filter patterns.

18. The image sensor of claim 12, wherein the color filter and micro-lens are self-aligned.

19. The image sensor of claim 12, wherein the protection layer comprises a nitride layer.
